(19) United States
(12) Patent Application Publication
(10) Pub. No.: US 2010/0243372 A1
(43) Pub. Date: Sep. 30, 2010

(54) FIREMAN'S COMPACT SAFETY DRAG HARNESS

(76) Inventor: JUSTIN M. WILKINSON, E. Alton, IL (US)

Correspondence Address: DON W. WEBER, 235 BRISTOL, TROY, IL, 62294, US

(21) Appl. No.: 12/411,874

(22) Filed: Mar. 26, 2009

(51) Int. Cl. A62B 35/00; A62C 39/00

(52) U.S. Cl. 182/3; 224/184

(57) ABSTRACT

A fire safety harness for dragging a downed fireman to safety in a burning building is made of flat, strong, flexible webbing material and has a Y-shape. The Y-shaped harness has two short legs approximately three feet in length and a long leg approximately six feet in length. In a one-man rescue, the long leg is attached to the victim and the single rescuer's two arms are placed through the two short even legs, respectively. In a two-man rescue, one short leg of the harness is attached to the victim. Each of the two rescuers places one arm through the remaining one short and one long leg, respectively. The different lengths of the short and long legs enable the two rescuers to walk in staggered positions.

### BACKGROUND OF THE INVENTION

This invention relates to the field of fire safety. More particularly, a fire safety harness is presented that is lightweight and compact and provides a drag harness to rescue fallen firefighters in a burning building.

In the field of fire safety and firefighting, firemen often are compelled to enter a burning building to fight the fire. Firemen are equipped with a variety of gear, including a helmet, fire resistant coat, and boots and in some circumstances a breathing tank strapped to their back. Some firemen wear safety gear specifically designed for the rare occasion when a downed fireman must be rescued by dragging the victim from a burning building. One example of this type of gear attached to the fireman's air tank is found in U.S. Pat. No. 4,161,266 issued to Howarth. The Howarth device is an elongated lifeline carried by a fireman attached to his air tank. While the Howarth device is an important safety device it adds considerable weight to the already heavy fire suit and is bulky in size. Safety devices for only rare occurrences must have both utility and be lightweight and compact. It is an object of this invention to provide a compact lightweight safety harness that is useful in rescue operations.

In certain emergencies a fireman may be overcome with smoke or rendered unconscious or injured by falling debris or other accidental circumstances. When this occurs, it may become necessary for one or more other firemen to carry or drag the injured or unconscious fireman from the building. Special coats have been designed to enable such rescue operations. One such safety coat is found in the 2002 patent issued to Jordan, U.S. Pat. No. 6,487,725. The Jordan safety harness with support line discloses a jacket with a built-in support line. The support line 20 is built into a pocket with a releasable flap 36 in the jacket and is manufactured integral with the coat itself. However, not all firemen can obtain such expensive jackets. It is an object of this invention to provide a safety harness for use in emergency situations that can be added to existing fireman's clothing.

In such emergency situation as above, it is often impractical to obtain a stretcher or other equipment to transport the injured fireman. It would be beneficial if a lightweight, compact safety harness capable of transporting a downed fireman could be provided that could be added on to existing fire clothing. It is an object of this invention to provide a piece of safety equipment capable of transporting an injured or unconscious fireman from a building that may be carried on a rescuing fireman's person or in a coat pocket.

Since most mishaps in burning buildings involving downed firemen require immediate action, it is often highly dangerous or impossible to leave the injured fireman in order to secure rescue equipment. It would be advantageous if a rescue device capable of assisting a fireman in dragging another fireman was available that is strong, lightweight and compact such that it could be carried on the person of each fireman and available for ready and instantaneous deployment when needed. It is a still further object of this invention to provide a strong, lightweight, compact harness to assist a fireman in recuing a fallen fireman or other injured or unconscious victim.

Other and further objects of this invention will become apparent upon reading the below described specification.

### BRIEF DESCRIPTION OF THE INVENTION

A fire safety harness is made of strong nylon “tubular” webbing. The webbing is flat and flexible and may be easily rolled into a cylindrical shape and stored in a fireman's coat or pants pocket. The harness has the general shape of a “Y”, with two short legs approximately 3 (three) feet in length and one longer leg approximately 6 (six) feet in length. The three legs are joined by sewing or by other suitable strong means to form a “Y”. Each of the three legs has a loop at the outer end large enough for a fireman dressed in full fire gear to slip his arm through the loop to enable the rescuing fireman to pull the harness by his shoulder.

In rescuing a downed fireman, one of the loops at the end of one leg is attached to the downed fireman's breathing apparatus, either by using a girth hitch, by looping the leg around the apparatus or by using a carabineer oval clamp. The remaining two legs are used to drag the victim to safety. If one fireman is affecting the rescue, the long leg is affixed to the victim and the short legs are used by the rescuer. The rescuer slips both arms through loops on the remaining equal length short harness legs and drags the victim to safety. If two firemen are affecting the rescue, one short leg is attached to the victim and the remaining short and long offset legs are used by two separate rescuers. The offset legs enable two firemen rescuers to pull the victim while walking in an offset position rather than an awkward side-by-side position.

### BRIEF DESCRIPTION OF THE DRAWINGS

FIG. 1 is a perspective view of the fire safety harness.

FIG. 2 is a perspective cut view of the device showing the two flat short legs and one long leg and end loops.

FIG. 3 is a detailed view of the device shown connected to a downed fireman by use of a carbineer.

FIG. 4 is perspective view of the device in a one-man rescue operation with the firemen shown in phantom lines.

FIG. 5 is a perspective view of the device in a two-man rescue operation with the firemen shown in phantom lines.

FIG. 6 is a perspective view of the device shown coiled for storage.

### DETAILED DESCRIPTION OF THE INVENTION

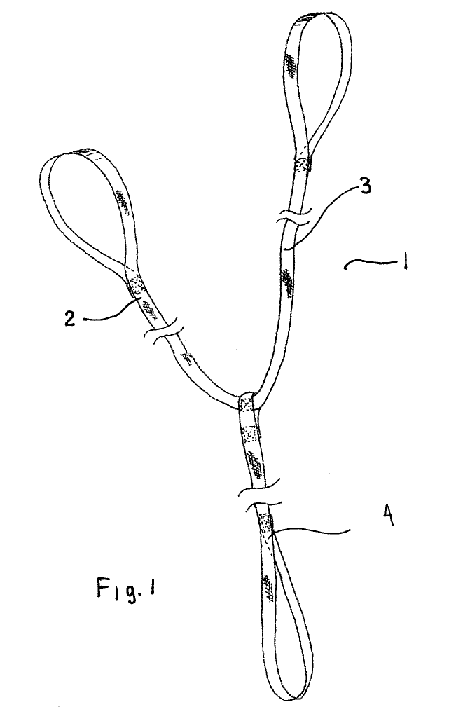

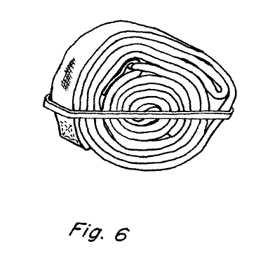

As shown in FIG. 1, a fireman's safety drag harness 1 is made of strong, flat nylon webbing. Although the trade usage name for the webbing is “tubular webbing,” the webbing is actually flat as shown. The harness 1 is flat, approximately one-eighth to one-quarter inch thick and approximately 1 (one) inch wide. The drag harness is flat and flexible and may be rolled into a cylindrical shape for compact storage as shown in FIG. 6.

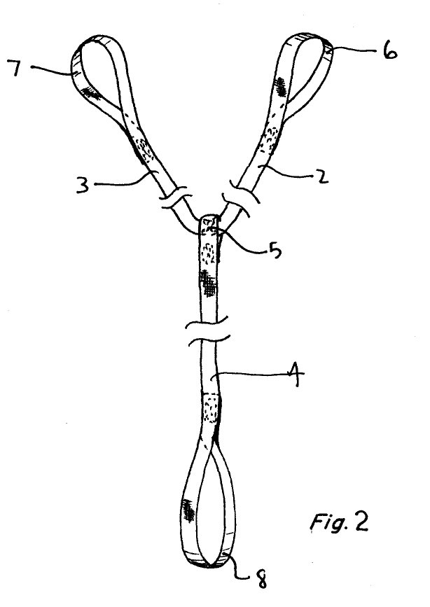

The drag harness is in the shape of a “Y”, with equal length short legs 2 and 3 and one longer leg 4. The three legs are joined at a central joining point 5, preferably by sewing, to form a “Y”. In the preferred embodiment the three legs are stitched together as shown in FIG. 1. The device may be manufactured using one unitary long length approximately 6 (six) feet in length stitched to a small loop at the central end 5 of the long leg 4 as shown in FIG. 2. Alternatively, the device may be manufactured using one length of webbing approximately 9 (nine) feet long attached to a short leg approximately 3 (three) feet long. A main feature of this device is to have two short (three feet) and one long (six feet) legs attached at a central location.

Long leg 4 has a distal end loop 8. Short leg 3 has a distal end loop 7. Short leg 2 has a distal end loop 6. These loops 6, 7 and 8 have a circumference of approximately 30 (thirty) inches. The loops 6, 7, and 8 have a diameter of approximately 10 (ten) inches when the loop is formed into a circular or oval shape as shown in FIG. 2. The dimensions for the loops are approximate and it is understood that the dimensions are meant as an illustration only and not a s precise limitation. However, each loop must be large enough to accommodate a fireman's arm and shoulder as will explained below.

The short legs 2 and 3 are approximately three feet in length from the distal loop end 6 and 7, respectively, to the central joining location 5. The long leg 4 is approximately 6 (six) feet in length from the distal loop end 8 to the central joining location 5.

All dimensions recited herein are for the preferred embodiment and are meant as an illustration of the preferred dimensions. The fire safety harness could have a width of one to five inches, depending on the strength parameters of the webbing used. The thickness could also vary while still keeping within the spirit and disclosure of this invention as long as it is thick enough to be strong for the intended use and thin enough to be flexible, lightweight and compact when rolled into a cylinder. It has been found that a thickness of one-eighth to one-quarter inch is preferred. Similarly, the lengths of each leg could vary, with the preferred short leg length being between three and four feet and the preferred long leg length being between five and eight feet.

The difference in the length dimensions of the short and long legs is critical, since the one long and two short lengths create the versatility which is an important part of this new invention. The one or two-man rescue operation described below can only be performed if the offset short and long leg dimensions are maintained in the device itself.

In addition to the dragging rescue function of the fire safety harness, the harness can also alternatively be used by two or more firemen to keep in contact with each other in a burning and smoky building. Since vision is often obscured, firemen can use the harness to keep in contact with each other when vision is minimal. Since each fireman can hold onto a loop end or part of the harness, it is important that the harness not be too long as it could become entangled in debris or other obstructions if it were not of a limited length.

Similarly, the length of the legs is important to the rescue operations described herein. The legs cannot be too short in the dragging operation, since legs that are too short would not allow the fireman to stand up or crouch while still keeping in contact with the victim through the harness. Conversely, legs that are too long would not be functional in the dragging operation. A harness that is too long would not keep the victim within the proper distance from a firefighter when dragging the victim through a smoky area often cluttered with downed ceiling or roofing tiles or other obstructions. If, for example, the long leg were nine or ten feet in length, the harness would likely become entangled with debris or could become dysfunctional when the victim must be dragged around corners of the house or building.

It is important to this new fire safety harness invention, however, that the short legs 2 and 3 each be shorter than the long leg 4. The offset distances created by the short and long leg lengths enable a one or two man rescue to be accomplished as follows.

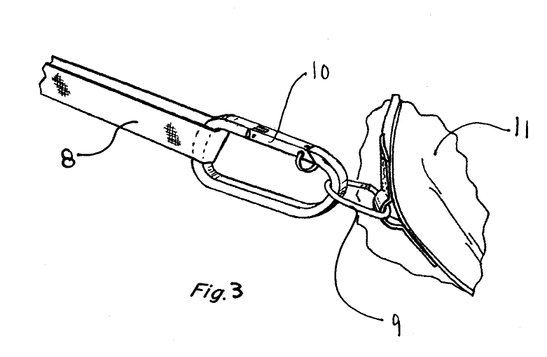

When a single fireman encounters a downed fireman in a building, he deploys the harness by attaching the long distal, looped end 8 of the long leg 4 of the harness to the victim's breathing apparatus strap or coat harness. This attachment may be accomplished by securing the loop 8 around an attaching ring 9 to the victim fireman's coat 11 or breathing apparatus strap. A carbineer 10 may be used to secure the distal loop 8 to the victim's coat 11 if it is provided with a built-in harness strap. The loop end 8 may also be attached to the breathing apparatus ring on the downed fireman by use of the carbineer 10. The attachment of the loop end 8 of long leg 4 to a suitable attaching ring 9 is shown in FIG. 3.

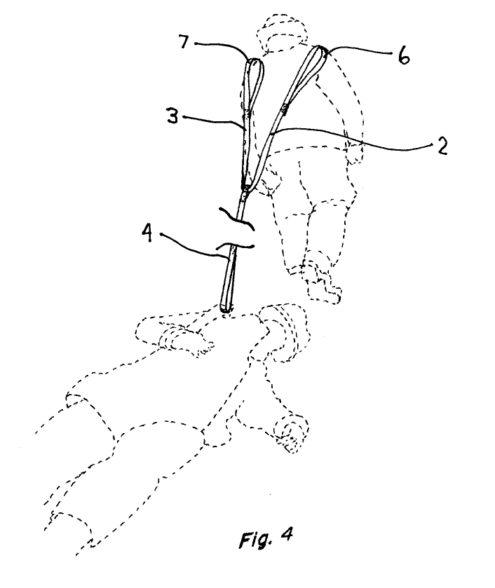

A one-man rescue operation is shown in FIG. 4. Once the long leg 4 of the fire safety harness 1 is secured to the fallen fireman in a one-man rescue operation, the rescuer places his arms through the remaining loops 6 and 7 at the distal ends of the two remaining even short legs 2 and 3. The rescuer may then drag the victim to safety using the fire safety harness. The two even short legs 2 and 3 enable the single fireman to drag the victim leaving only approximately nine feet between the rescuer's shoulders and the fallen victim. Here the length dimensions of the fire safety harness become important because a harness that is too long would hamper the rescue in a burning building that is full of furniture, debris, corners or other obstructions.

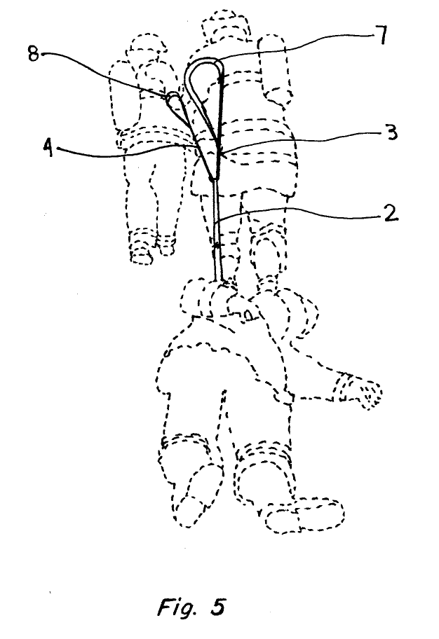

As best shown in FIG. 5, a unique aspect of this invention is the alternate two-man rescue capability of the device. In burning buildings, it is often necessary to drag an unconscious or injured victim through narrow doorways or other pathway restrictions. Two firemen walking side-by-side would not be able to navigate such narrow obstructions. Due to the unique dimensions of the instant fire safety harness, this problem is solved. In such two-man rescue situations, one short end 2 of the device is attached to the victim as described above, leaving one short 3 and one long end 4 free. As shown in FIG. 5, one of the rescuing firemen can then place his arm through the looped end 7 of the remaining short leg 3 while the other rescuing fireman places his arm through the looped end 8 of the long leg 4. Using the one long and two short legs, the rescuing firemen are staggered approximately three feet apart as shown in FIG. 5, rather than side-by-side. This staggered walking position enables a two man rescue operation to be better able to drag the victim to safety through narrow passageways strewn with debris and other obstacles.

In addition to the dragging and fireman contact uses described above, the fire safety harness can also be used to carry an injured fireman or victim. When used in this manner, one of the victim's legs is placed through one of the short leg 2 harness loops 6 and the victim's other leg is placed through the remaining short leg 3 harness loop 7. The long leg 4 then becomes the lifting and/or carrying leg.

The fire safety rescue harness can be conveniently rolled into a cylindrical shape, as shown in FIG. 6, with the width of the webbing being the height of the roll. The harness can then be placed into the coat or pants pocket of the fireman or could be attached to the firefighter's uniform using a carrying pouch. When the harness is needed, it may be quickly retrieved from its carrying pouch or pocket.

Having fully described my device, I claim:

1. A fire safety harness for dragging an injured fireman or other victim to safety, comprising:
(a) two flat, short legs each having a distal looped end and a central end;
(b) one flat, long leg having a distal looped end and a central end;
wherein, the central ends of said short legs and long leg are joined together to form a flat, Y-shaped harness for fire rescue operations.

2. A fire safety harness for dragging an injured fireman or other victim to safety as in claim 1, wherein said short legs are at least three feet in length but not more than four feet in length and wherein said long leg is from five to eight feet in length.

3. A fire safety harness for dragging an injured fireman or other victim to safety as in claim 1, wherein said short legs are three feet in length and said long leg is six feet in length.

4. A fire safety harness for dragging an injured fireman or other victim to safety as in claim 1, further comprising a carbineer for attaching a distal loop of one of said legs to the downed fireman or other victim.

5. A fire safety harness for dragging an injured fireman or other victim to safety as in claim 1, wherein said flat harness may be rolled into a compact cylindrical form for storage.

6. A one-man method of rescuing a downed fireman or other victim, comprising the steps of:
(a) attaching the distal loop of the long leg of the fire safety harness device described in claim 1 to a downed fireman or other victim;
(b) placing each arm of the rescuing fireman through the distal loop of each short leg of said fire safety harness, respectively;
(c) dragging said downed fireman or other victim to safety.

7. A two-man method of rescuing a downed fireman or other victim, comprising the steps of:
(a) attaching the distal loop of one of the short legs of said fire safety harness device described in claim 1 to a downed fireman or other victim;
(b) a first rescuer placing one arm through the distal loop of the long leg of said fire safety harness;
(c) a second rescuer placing one arm through the distal loop of the remaining short leg of said fire safety harness;
(d) said first and second offset firemen dragging said downed fireman or other victim to safety.
